(19) United States
(12) Patent Application Publication
(10) Pub. No.: US 2024/0110505 A1
(43) Pub. Date: Apr. 4, 2024

(54) GAS TURBINE

(71) Applicant: HONDA MOTOR CO., LTD., Tokyo (JP)

(72) Inventors: Yasuharu Kamoi, Wako-shi (JP); Takuma Kudo, Wako-shi (JP)

(21) Appl. No.: 18/473,368

(22) Filed: Sep. 25, 2023

(30) Foreign Application Priority Data
Sep. 29, 2022 (JP) 2022-156263

(51) Int. Cl. F02C 3/14; F02C 7/264

(52) U.S. Cl. CPC F02C 3/14; F02C 7/264; F05D 2240/35; F05D 2260/99

(57) ABSTRACT

A gas turbine includes a compressor, a combustor, an air lead-out member, an outer peripheral cover portion, and an auxiliary device member. The outer peripheral cover portion includes outer peripheral concave portions and outer peripheral convex portions, and is formed in a manner so that the outer peripheral concave portions recessed radially inward of the combustor so as to enter between mutually-adjacent combustion cylinders among the plurality of combustion cylinders and the outer peripheral convex portions protruding radially outward of the combustor so as to extend along outer peripheral surfaces of the plurality of combustion cylinders are alternately and continuously arranged in a circumferential direction of the combustor. The auxiliary device member is attached to one of the outer peripheral concave portions.

### CROSS-REFERENCE TO RELATED APPLICATIONS

This application is based upon and claims the benefit of priority from Japanese Patent Application No. 2022-156263 filed on Sep. 29, 2022, the contents of which are incorporated herein by reference.

### BACKGROUND OF THE INVENTION

### Field of the Invention

The present invention relates to a gas turbine.

### Description of the Related Art

For example, JP 6326429 B2 discloses a gas turbine including a combustor having an annular combustion chamber, an annular outer peripheral cover portion that covers the combustor from the radially outward side, and an injector that supplies fuel to the combustion chamber. The outer peripheral cover portion is formed in an annular shape. The injector extends in a radial direction of the combustor. A distal end portion of the injector is positioned in the combustion chamber, and a proximal end portion of the injector is held by the outer peripheral cover portion. An air flow path through which air supplied from the compressor flows is formed between the combustor and the outer peripheral cover portion.

### SUMMARY OF THE INVENTION

Incidentally, when the outer circumferential surface of the combustor is cooled by the air flowing through the air flow path, the narrower the flow path width of the air flow path (the distance in the radial direction of the combustor) is, the higher the flow velocity of the air flowing through the air flow path becomes, so that the outer circumferential surface of the combustor can be efficiently cooled.

In the gas turbine disclosed in JP 6326429 B2 mentioned above, the outer peripheral cover portion extends in an annular shape, and the injector (auxiliary device member) extends in the radial direction of the combustor. Therefore, in the gas turbine, even if the outer diameter of the outer peripheral cover portion is reduced in order to narrow the flow path width of the air flow path, the end position of the auxiliary device member on the radially outward side of the combustor does not change. Therefore, the outer diameter of the gas turbine cannot be reduced.

The present invention has the object of solving the aforementioned problem.

According to an aspect of the present invention, there is provided a gas turbine including a compressor, a combustor including a plurality of combustion cylinders arranged annularly, an air lead-out member configured to lead out air supplied from the compressor, to the combustor, an annular outer peripheral cover portion configured to cover the combustor from a radially outward side of the combustor, and an auxiliary device member provided in the outer peripheral cover portion, wherein an air flow path through which the air led out from the air lead-out member flows is formed between the combustor and the outer peripheral cover portion, the plurality of combustion cylinders extend in an axial direction of the combustor, the outer peripheral cover portion includes outer peripheral concave portions and outer peripheral convex portions, and is formed in a manner so that the outer peripheral concave portions recessed radially inward of the combustor so as to enter between mutually-adjacent combustion cylinders among the plurality of combustion cylinders and the outer peripheral convex portions protruding radially outward of the combustor so as to extend along outer peripheral surfaces of the plurality of combustion cylinders are alternately and continuously arranged in a circumferential direction of the combustor, and the auxiliary device member is attached to one of the outer peripheral concave portions.

According to the present invention, since the outer peripheral cover portion is formed along the outer peripheral surfaces of the plurality of combustion cylinders annularly arranged, the flow path width of the air flow path can be efficiently narrow. As a result, the flow velocity of the air flowing through the air flow path can be increased, so that the outer peripheral surfaces of the combustion cylinders can be effectively cooled. Further, since the auxiliary device member is attached to one of the outer peripheral concave portions of the outer peripheral cover portion, the protruding length of the auxiliary device member protruding radially outward of the combustor relative to the outer peripheral surface of the outer peripheral cover portion can be shortened, as compared with the case where the auxiliary device member is attached to one of the outer peripheral convex portions of the outer peripheral cover portion. Therefore, the outer diameter of the gas turbine can be reduced.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a vertical cross-sectional view of a gas turbine according to an embodiment of the present invention;

FIG. 2 is a cross-sectional view taken along line II-II of FIG. 1;

FIG. 3 is a partial cross-sectional perspective view of a combustor of FIG. 1;

FIG. 4 is an enlarged view of FIG. 1; and

FIG. 5 is a cross-sectional view taken along line V-V of FIG. 4.

### DETAILED DESCRIPTION OF THE INVENTION

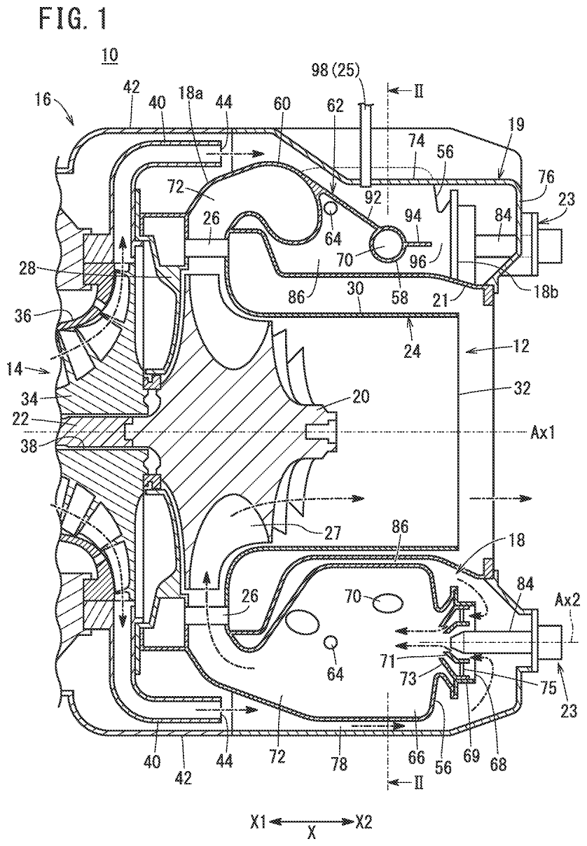

As shown in FIG. 1, a gas turbine 10 according to an embodiment of the present invention is used, for example, as a power source of a generator. The gas turbine 10 may be used as a power source of an aircraft or a ship. The gas turbine 10 includes a turbine portion 12, a compressor 14, a diffuser 16, a combustor 18, a casing member 19, an inner peripheral cover portion 21, a plurality of fuel supply units 23, and an auxiliary device member 25.

The turbine portion 12 includes a turbine 20, a shaft 22, and a turbine housing 24. The turbine 20 is made of a metal material having heat resistance. The turbine 20 is configured as a radial turbine. The turbine 20 has a plurality of blades 27 for receiving combustion gas introduced from a radially outward side.

The shaft 22 extends in one direction (the direction of arrow X). One end portion (an end portion in the direction of arrow X1) of the shaft 22 is coupled to, for example, an unillustrated output shaft. The output shaft may be a rotating shaft of a generator, a rotating shaft of a propeller of an aircraft or a ship, or the like. When the gas turbine 10 is used as a jet engine or the like, the output shaft may not be connected to one end portion of the shaft 22. Another end portion (an end portion in the direction of arrow X2) of the shaft 22 is coupled to the turbine 20. An axis of the shaft 22 is located on a rotation axis of the turbine 20.

The turbine housing 24 accommodates the turbine 20. The turbine housing 24 covers the turbine 20 from a radially outward side. The turbine housing 24 includes a turbine nozzle 26, a first housing 28 and a second housing 30. The turbine nozzle 26 is formed in an annular shape. The turbine nozzle 26 is disposed so as to cover the blades 27 of the turbine 20 from the radially outward side. The turbine nozzle 26 guides the combustion gas from the combustor 18, to the blades 27 of the turbine 20. The turbine nozzle 26 is supported by the first housing 28 and the second housing 30.

The first housing 28 is formed in an annular shape so as to cover a portion (one end portion of the turbine 20) of the turbine 20 in the direction of arrow X1 relative to the turbine nozzle 26. The second housing 30 is formed in an annular shape so as to cover a portion (another end portion of the turbine 20) of the turbine 20 in the direction of arrow X2 relative to the turbine nozzle 26. The second housing 30 extends in the direction of arrow X2 compared to the other end portion of the turbine 20. An exhaust port 32 facing in the direction of arrow X2 is formed at an extending end of the second housing 30. The exhaust port 32 discharges the combustion gas in the turbine housing 24 to outside.

The compressor 14 is configured as, for example, a centrifugal compressor. The compressor 14 includes a compressor wheel 34 and a shroud case 36 that accommodates the compressor wheel 34. An insertion hole 38 into which the shaft 22 is inserted is formed in the compressor wheel 34.

A rotation axis of the compressor wheel 34 is located on the axis of the shaft 22. The compressor wheel 34 is coupled to the shaft 22 for rotation together with the shaft 22. The shaft 22 transmits the rotational force of the turbine 20 to the compressor wheel 34 to rotate the compressor wheel 34.

The shroud case 36 covers the compressor wheel 34. The shroud case 36 is provided with an opening (not shown) for allowing external air to flow into the shroud case 36. The air inside the shroud case 36 is compressed by the rotation of the compressor wheel 34.

The diffuser 16 includes an air lead-out member 40 that leads out the air (compressed air) supplied from the compressor 14 to the combustor 18, and a diffuser housing 42 that covers the air lead-out member 40. The air lead-out member 40 is located radially outward of the compressor wheel 34. The air lead-out member 40 leads the air supplied from the compressor 14 in the direction of arrow X2. A lead-out port 44 of the air lead-out member 40 is oriented in the direction of arrow X2.

The combustor 18 is formed of a metal material having heat resistance, in an annular shape. An axis Ax1 of the combustor 18 is disposed coaxially with the turbine 20 and the shaft 22. The combustor 18 has a first end portion 18a which is one end portion (an end portion in the direction of arrow X1) in the axial direction of the combustor 18 and a second end portion 18b which is another end portion (an end portion in the direction of arrow X2) in the axial direction.

As shown in FIGS. 1 to 3, the combustor 18 is formed in an annular shape. The lead-out port 44 of the air lead-out member 40 is located radially outward of the first end portion 18a of the combustor 18 (see FIG. 1). The combustor 18 includes a plurality of combustion cylinders 56, a plurality of communication pipes 58, an annular lead-out portion 60, a plurality of guide wall portions 62, and a plurality of through holes 64 (dilution holes).

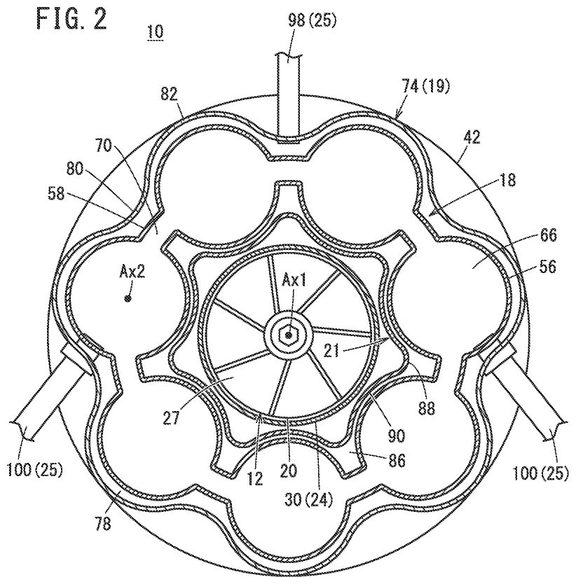

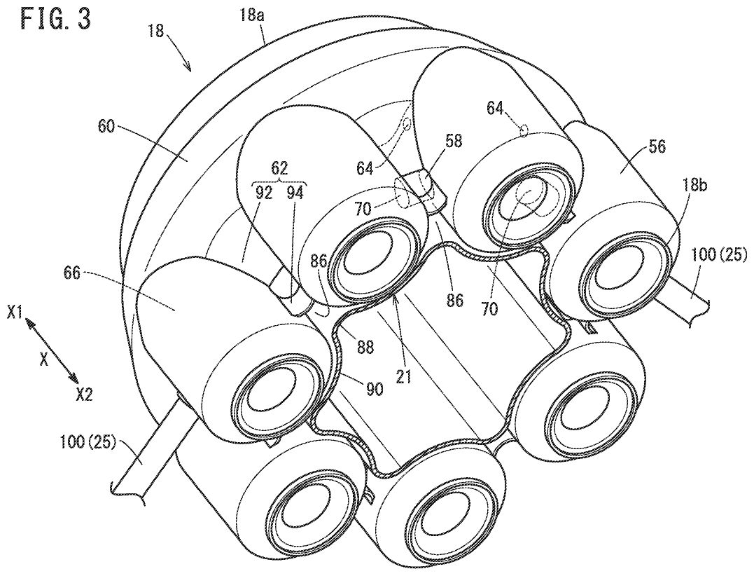

The plurality of combustion cylinders 56 extend in the axial direction (the direction of arrow X) of the combustor 18 (see FIGS. 1 and 3). In FIG. 2, the plurality of combustion cylinders 56 are annularly arranged. More specifically, in the example of FIG. 2, seven combustion cylinders 56 are arranged at equal intervals around the axis Ax1 of the combustor 18. The number of the combustion cylinders 56 is not limited to seven. The combustion cylinder 56 is formed in a cylindrical shape.

As shown in FIGS. 1 and 3, the annular lead-out portion 60 is connected to one end portion (an end portion in the direction of arrow X1) of each of the combustion cylinders 56. At another end portion (an end portion in the direction of arrow X2) of each of the combustion cylinders 56, a swirling flow generating blade portion 69 having an air flow inlet 68 for allowing air to flow into the upstream portion of a combustion chamber 66 inside each combustion cylinder 56 is provided. The air flow inlet 68 is located at the second end portion 18b of the combustor 18. The air flow inlet 68 faces in the direction of arrow X2. The hole diameter (diameter) of the air flow inlet 68 is smaller than the inner diameter of the intermediate portion in the extending direction of the combustion cylinders 56.

In FIG. 1, the swirling flow generating blade portion 69 includes an inner tubular body 71, an outer tubular body 73, and a swirling blade 75. A distal end portion of an injector 84, which will be described later, of the fuel supply unit 23 is positioned inside the inner tubular body 71. A space through which air flows is formed between the inner tubular body 71 and the distal end portion of the injector 84. A space through which air flows is formed between the inner tubular body 71 and the outer tubular body 73. The swirling blade 75 generates a swirl flow in the air flowing into the combustion chamber 66 from the air flow inlet 68. The swirling blade 75 is provided between the inner tubular body 71 and the outer tubular body 73. Although not shown in detail, the swirling blade 75 is also provided between the inner tubular body 71 and the distal end portion of the injector 84.

In FIGS. 2 and 3, each of the communication pipes 58 connects the combustion cylinders 56 adjacent to each other in the circumferential direction of the combustor 18. An inner hole 70 of each of the communication pipes 58 allows the combustion chambers 66 of the combustion cylinders 56 adjacent to each other in the circumferential direction of the combustor 18 to communicate with each other (see FIG. 2). The communication pipes 58 are located at intermediate portions in the extending direction of the combustion cylinders 56 (FIGS. 2 and 3).

The annular lead-out portion 60 is formed in an annular shape (see FIGS. 1 and 3). In FIG. 1, the annular lead-out portion 60 is connected to the turbine nozzle 26. The annular lead-out portion 60 has an annular lead-out flow path 72 communicating with the plurality of combustion chambers 66. The lead-out flow path 72 leads the combustion gas generated in the plurality of combustion chambers 66 to the turbine nozzle 26. Specific configurations of the plurality of guide wall portions 62 and the through holes 64 will be described later.

The casing member 19 includes an outer peripheral cover portion 74 and an end cover portion 76. The outer peripheral cover portion 74 is formed in an annular shape (see FIG. 2). The outer peripheral cover portion 74 covers the combustor 18 from a radially outward side of the combustor 18.

In FIG. 1, one end portion (an end portion in the direction of arrow X1) of the outer peripheral cover portion 74 is coupled to the diffuser housing 42. Another end portion (an end portion in the direction of arrow X2) of the outer peripheral cover portion 74 is located further in the direction of arrow X2 than the second end portion 18b of the combustor 18. An air flow path 78 is formed between the combustor 18 and the outer peripheral cover portion 74. The air flow path 78 causes the air led out from the air lead-out member 40 to flow from the first end portion 18a to the second end portion 18b of the combustor 18. The air flow path 78 extends annularly.

In FIG. 2, the outer peripheral cover portion 74 is formed such that outer peripheral concave portions 80 and outer peripheral convex portions 82 are alternately and continuously arranged in the circumferential direction of the combustor 18. The outer peripheral concave portions 80 are recessed radially inward of the combustor 18 so as to enter between the combustion cylinders 56 adjacent to each other. The outer peripheral concave portions 80 protrude radially inward of the combustor 18 in an arc shape. The outer peripheral convex portions 82 protrude radially outward of the combustor 18 along the outer circumferential surfaces of the plurality of combustion cylinders 56. The outer peripheral convex portions 82 protrude radially outward of the combustor 18 in an arc shape.

Accordingly, the flow path width of the air flow path 78 (the width in the radial direction of the combustor 18) can be set to be narrow.

As shown in FIG. 1, the end cover portion 76 is formed in an annular shape. The end cover portion 76 covers the combustor 18 from a side in the direction of arrow X2. The end cover portion 76 extends radially inward of the combustor 18 from an end portion of the outer peripheral cover portion 74 in the direction of arrow X2. The end cover portion 76 covers the air flow inlet 68 of each combustion cylinder 56.

The fuel supply unit 23 is provided in each of the plurality of combustion cylinders 56. That is, the fuel supply units 23 are provided in the same number as the combustion cylinders 56. Each of the fuel supply units 23 includes the injector 84. A distal end portion of the injector 84 is inserted into the combustion chamber 66 from the air flow inlet 68 of the combustion cylinder 56. The center line (fuel injection port) of the injector 84 is located on the axis Ax2 of the combustion cylinder 56. The injector 84 extends along the axial direction (the direction of arrow X) of the combustion cylinder 56. The injector 84 injects fuel into the combustion chamber 66. The injector 84 is attached to the end cover portion 76.

The inner peripheral cover portion 21 is formed in an annular shape (see FIG. 2). The inner peripheral cover portion 21 covers the combustor 18 from the radially inward side. One end portion (an end portion in the direction of arrow X1) of the inner peripheral cover portion 21 is connected to the annular lead-out portion 60. Another end portion (an end portion in the direction of arrow X2) of the inner peripheral cover portion 21 is coupled to the end cover portion 76. An inner space 86 into which air flows from the air flow path 78 via a communication path 96 provided in the second end portion 18b of the combustor 18 is formed between the combustor 18 and the inner peripheral cover portion 21. The inner space 86 extends annularly.

In FIG. 2, the inner peripheral cover portion 21 is formed such that inner peripheral concave portions 88 and inner peripheral convex portions 90 are alternately and continuously arranged in the circumferential direction of the combustor 18. The inner peripheral concave portions 88 are recessed radially outward of the combustor 18 so as to enter between the combustion cylinders 56 adjacent to each other. The inner peripheral convex portions 90 protrude radially inward of the combustor 18 along the outer circumferential surfaces of combustion cylinders 56. The inner peripheral convex portions 90 protrude radially inward of the combustor 18 in an arc shape.

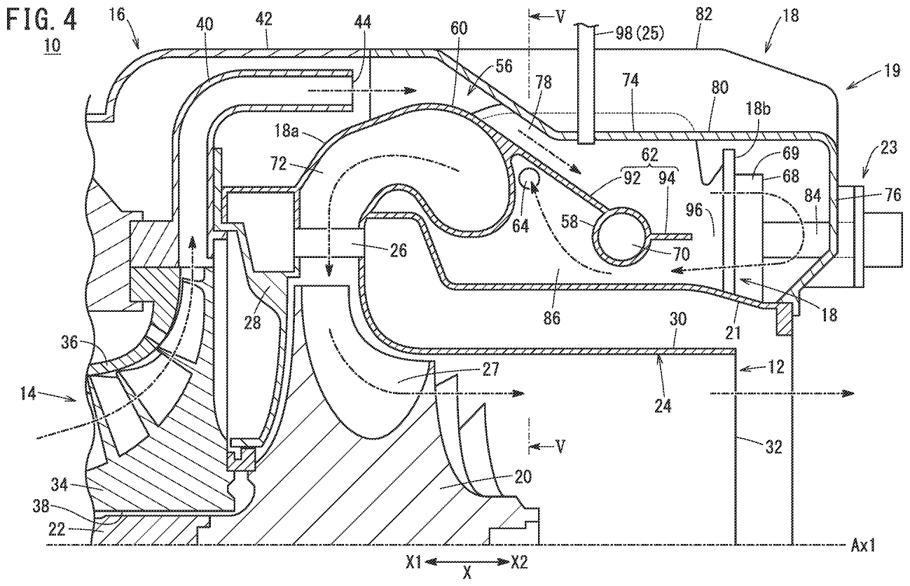

As shown in FIGS. 3 and 4, the guide wall portions 62 are provided so as to connect the combustion cylinders 56 adjacent to each other in the circumferential direction of the combustor 18. That is, each of the guide wall portions 62 is provided between the combustion cylinders 56 adjacent to each other in the circumferential direction of the combustor 18. The guide wall portion 62 guides air from the air flow path 78 to the inner space 86 via the communication path 96 (see FIG. 4).

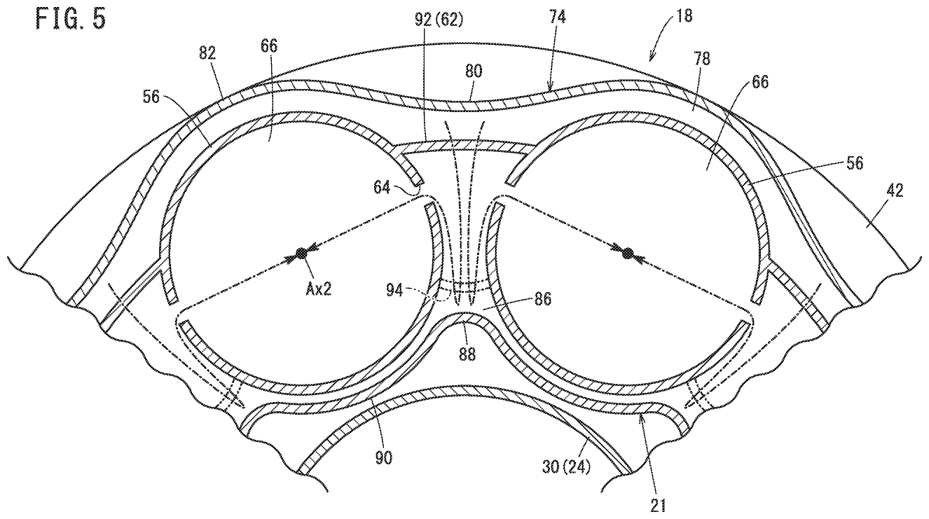

The guide wall portion 62 includes a first wall portion 92 and a second wall portion 94. The first wall portion 92 extends from the communication pipe 58 toward the first end portion 18a (in the direction of arrow X1) of the combustor 18. The first wall portion 92 extends so as to be inclined radially outward of the combustor 18, viewed in the direction of arrow X1. An extending end portion of the first wall portion 92 is connected to the annular lead-out portion 60. When viewed in the axial direction of the combustor 18, the first wall portion 92 protrudes radially outward of the combustor 18 in an arc shape (see FIG. 5). Note that the cross section of the first wall portion 92 may protrude radially inward of the combustor 18 in an arc shape.

As shown in FIGS. 3 and 4, the second wall portion 94 extends from the communication pipe 58 toward the second end portion 18b of the combustor 18 (in the direction of arrow X2). The extending end portion of the second wall portion 94 is located at a position shifted in the direction of arrow X1 from the other end portion of the combustion cylinder 56. The second wall portion 94 protrudes radially inward of the combustor 18 in an arc shape when viewed in the axial direction of the combustor 18 (see FIG. 3). Note that the cross section of the second wall portion 94 may protrude radially outward of the combustor 18 in an arc shape.

In FIG. 4, the communication pipes 58 and the guide wall portions 62 partition the space between the outer peripheral cover portion 74 and the inner peripheral cover portion 21 into the air flow path 78 located radially outward of the combustor 18 and the inner space 86 located radially inward of the combustor 18. In this case, the combustor 18 has the communication path 96 that allows the air flow path 78 and the inner space 86 to communicate with each other at the second end portion 18b (the end portion in the direction of arrow X2) of the combustor 18.

As shown in FIGS. 4 and 5, two through holes 64 are provided for each combustion cylinder 56. These through holes 64 guide the air in the inner space 86 to the downstream side of the combustion chamber 66. The through holes 64 are located between the first wall portions 92 and the inner peripheral cover portion 21. The through holes 64 are adjacent to a boundary portion between the first wall portions 92 and the annular lead-out portion 60. Each of the through holes 64 is formed at a position adjacent to the annular lead-out portion 60 on the outer peripheral surface of the combustion cylinder 56 (the end portion in the direction of arrow X1). In FIG. 4, the through holes 64 are located in the direction of arrow X1 relative to the communication pipes 58. The through holes 64 are located radially outward of the combustor 18 relative to the communication pipes 58.

As shown in FIG. 5, the through holes 64 open radially inward of the combustion cylinders 56. In other words, each of the through holes 64 opens toward the axis Ax2 of the combustion cylinder 56. In the axial direction of the combustion cylinder 56, the two through holes 64 are at the same height position. The two through holes 64 are disposed so as to face each other across the axis Ax2 of the combustion cylinder 56. The two through holes 64 are positioned so as to be shifted by 180° in the circumferential direction of the combustion cylinder 56.

As shown in FIGS. 1 and 2, the auxiliary device member 25 includes one sensor 98 and two ignition devices 100. The sensor 98 detects a physical quantity of the air flowing through the air flow path 78. More specifically, the sensor 98 is, for example, a pressure sensor that detects the pressure of the air flowing through the air flow path 78. The sensor 98 extends in one direction. The sensor 98 is attached to one of the outer peripheral concave portions 80 of the outer peripheral cover portion 74 such that a distal end thereof is exposed to the air flow path 78. The sensor 98 extends in the radial direction of the combustor 18 in a state of being attached to the outer peripheral cover portion 74. The sensor 98 is located in the direction of arrow X1 from the communication pipe 58. However, the mounting position of the sensor 98 can be appropriately set in the axial direction of the combustor 18.

In FIG. 2, each of the ignition devices 100 is an igniter that discharges in the combustion chamber 66. Each of the ignition devices 100 extends in its own direction (or, one of the ignition devices 100 extends in one direction). Each of the ignition devices 100 is attached to one of the outer peripheral concave portions 80 of the outer peripheral cover portion 74 such that a distal end thereof is exposed to the combustion chamber 66. The ignition devices 100 are attached to the outer peripheral concave portions 80 different from the outer peripheral concave portion 80 to which the sensor 98 is attached. Further, the two ignition devices 100 are attached to the outer peripheral concave portions 80 different from each other. In this case, the two ignition devices 100 are attached to the outer peripheral cover portion 74 so as to be located at positions farthest from each other in the circumferential direction of the combustor 18.

Each of the ignition devices 100 extends so as to be inclined with respect to the radial direction of the combustor 18 in a state of being attached to the outer peripheral cover portion 74. The tip of the ignition device 100 faces the axis Ax2 of the combustion cylinder 56. The ignition device 100 is disposed such that the position of the ignition device 100 corresponds to the position of the communication pipe 58 in the axial direction of the combustor 18. The number of ignition devices 100 may be one. However, when two ignition devices 100 are provided, a mixture gas (fuel and air) in the combustion chambers 66 can be ignited even if one of the ignition devices 100 fails.

As shown in FIGS. 1 and 4, in the gas turbine 10 described above, the air (compressed air) supplied from the compressor 14 is led out from the lead-out port 44 of the air lead-out member 40 to the air flow path 78. The air led out from the lead-out port 44 to the air flow path 78 flows along the guide wall portions 62 and the combustion cylinders 56 to the second end portion 18b of the combustor 18 in the direction of arrow X2, and then hits the end cover portion 76 in the communication path 96 to change its direction by 180° and is guided to the inner space 86. At this time, a portion of the air flows into the combustion chambers 66 through the air flow inlets 68 (see FIG. 1).

In each of the combustion chambers 66, the air flowing in from the air flow inlet 68 and the fuel injected from the injector 84 are mixed. At startup of the gas turbine 10, the ignition devices 100 discharge in the combustion chambers 66. As a result, flame is generated in the combustion chambers 66. The flame generated in the combustion chambers 66 by the ignition devices 100 is transmitted through the inner holes 70 of the communication pipes 58 to the combustion chambers 66 of the combustion cylinders 56 to which the ignition device 100 is not attached (see FIG. 2). Thus, flames can be generated in the combustion chambers 66 of all the combustion cylinders 56. In each of the combustion chambers 66, a portion (central portion) on the axis Ax2 of the combustion cylinder 56 has highest temperature.

In the present embodiment, the air guided to the inner space 86 flows into each of the combustion chambers 66 from the two through holes 64. At this time, as shown in FIG. 5, the air flowing into each of the combustion chambers 66 from the two through holes 64 collides (head-on collision) on the axis Ax2 of the combustion cylinder 56 on the downstream side of the combustion chamber 66. As a result, the air having a relatively low temperature can remain in the vicinity of the axis Ax2 portion (in the vicinity of the center) of the combustion cylinder 56. Therefore, the combustion gas in the central portion of the combustion chamber 66 can be diluted in a well-balanced manner. A portion of the air that has flowed into the combustion chamber 66 from the through hole 64 and collided head-on, flows toward the upstream side of the combustion chamber 66 and is mixed with the fuel and used for combustion. Therefore, the air required for combustion can be efficiently supplied to the combustion chamber 66.

Further, the combustion chambers 66 are also cooled by the air flowing outside the combustor 18. Specifically, as shown in FIG. 4, the air flowing through the air flow path 78 cools the outer peripheral surfaces of the combustion cylinders 56. In the present embodiment, since the outer peripheral cover portion 74 has a concave and convex shape corresponding to the shape of the annularly arranged combustion cylinders 56, the flow path width of the air flow path 78 is set to be relatively narrow (see FIG. 2). Therefore, the flow velocity of the air flowing through the air flow path 78 is increased, and the outer peripheral surfaces of the combustion cylinders 56 can be efficiently cooled.

Further, in the present embodiment, since the air in the inner space 86 where the air is likely to stay flows into the combustion chambers 66 from the through holes 64, the air is unlikely to stay in the inner space 86. Therefore, the outer peripheral surfaces of the combustion cylinders 56 can be efficiently cooled by the air flowing through the inner space 86.

The combustion gas in each of the combustion chambers 66 merges in the lead-out flow path 72 of the annular lead-out portion 60 and flows toward the turbine 20 via the turbine nozzle 26. Thus, the turbine 20 rotates. The rotational force of the turbine 20 is transmitted to the compressor wheel 34 via the shaft 22.

According to the present embodiment, the following effects are obtained.

According to the present embodiment, since the outer peripheral cover portion 74 is formed along the outer peripheral surfaces of the plurality of combustion cylinders 56 annularly arranged, the flow path width of the air flow path 78 can be efficiently set to be narrow. As a result, the flow velocity of the air flowing through the air flow path 78 can be increased, so that the outer peripheral surfaces of the combustion cylinders 56 can be effectively cooled. Further, since the auxiliary device members 25 are attached to the outer peripheral concave portions 80 of the outer peripheral cover portion 74, the protruding length of each of the auxiliary device members 25 protruding radially outward of the combustor 18 relative to the outer peripheral surface of the outer peripheral cover portion 74 can be shortened, as compared with the case where the auxiliary device members 25 are attached to the outer peripheral convex portions 82 of the outer peripheral cover portion 74. Therefore, the outer diameter of the gas turbine 10 can be reduced.

The auxiliary device members 25 includes the ignition device 100 extending in one direction and causing ignition in the combustion chamber 66 of one of the combustion cylinders 56. The extending direction of the ignition device 100 is inclined relative to the radial direction of the combustor 18.

According to such a configuration, the outer diameter of the gas turbine 10 can be effectively reduced.

The combustor 18 has the plurality of communication pipes 58 for allowing the combustion chambers 66 of the combustion cylinders 56 adjacent to each other to communicate with each other. The ignition device 100 and the communication pipes 58 are disposed such that a position of the ignition device 100 corresponds to a position of one of the communication pipes 58 in the axial direction of the combustor 18.

According to such a configuration, the flame generated by the ignition device 100 can be efficiently transmitted to the combustion chambers 66 of the combustion cylinders 56 to which the ignition device 100 is not attached via the inner holes 70 of the communication pipes 58.

The auxiliary device members 25 include the sensor 98 that detects a physical quantity of the air flowing through the air flow path 78.

According to such a configuration, the outer diameter of the gas turbine 10 can be reduced in a state in which the sensor 98 is attached to the outer peripheral cover portion 74.

The present embodiment discloses the following contents.

The above embodiment discloses the gas turbine (10) including the compressor (14), the combustor (18) including the plurality of combustion cylinders (56) arranged annularly, the air lead-out member (40) configured to lead out air supplied from the compressor, to the combustor, the annular outer peripheral cover portion (74) configured to cover the combustor from the radially outward side of the combustor, and the auxiliary device member (25) provided in the outer peripheral cover portion, wherein the air flow path (78) through which the air led out from the air lead-out member flows is formed between the combustor and the outer peripheral cover portion, the plurality of combustion cylinders extend in the axial direction of the combustor, the outer peripheral cover portion includes the outer peripheral concave portions (80) and the outer peripheral convex portions (82), and is formed in a manner so that the outer peripheral concave portions recessed radially inward of the combustor so as to enter between the mutually-adjacent combustion cylinders among the plurality of combustion cylinders and the outer peripheral convex portions protruding radially outward of the combustor so as to extend along the outer peripheral surfaces of the plurality of combustion cylinders are alternately and continuously arranged in the circumferential direction of the combustor, and the auxiliary device member is attached to one of the outer peripheral concave portions.

In the above gas turbine, the auxiliary device member may include the ignition device (100) extending in one direction and configured to cause ignition in the combustion chamber (66) of one of the combustion cylinders, and the extending direction of the ignition device may be inclined relative to the radial direction of the combustor.

In the above-described gas turbine, the combustor may include the plurality of communication pipes (58) configured to allow the combustion chambers of the combustion cylinders adjacent to each other to communicate with each other, and the ignition device and the plurality of communication pipes may be disposed in a manner so that the position of the ignition device corresponds to the position of one of the plurality of communication pipes in the axial direction of the combustor.

In the gas turbine described above, the auxiliary device member may include the sensor (98) configured to detect the physical quantity of the air flowing through the air flow path.

Moreover, it should be noted that the present invention is not limited to the disclosure described above, and various configurations may be adopted therein without departing from the essence and gist of the present invention.

1. A gas turbine comprising:
a compressor;
a combustor including a plurality of combustion cylinders arranged annularly;
an air lead-out member configured to lead out air supplied from the compressor, to the combustor;
an annular outer peripheral cover portion configured to cover the combustor from a radially outward side of the combustor; and
an auxiliary device member provided in the outer peripheral cover portion,
wherein an air flow path through which the air led out from the air lead-out member flows is formed between the combustor and the outer peripheral cover portion,
the plurality of combustion cylinders extend in an axial direction of the combustor,
the outer peripheral cover portion includes outer peripheral concave portions and outer peripheral convex portions, and is formed in a manner so that the outer peripheral concave portions recessed radially inward of the combustor so as to enter between mutually-adjacent combustion cylinders among the plurality of combustion cylinders and the outer peripheral convex portions protruding radially outward of the combustor so as to extend along outer peripheral surfaces of the plurality of combustion cylinders are alternately and continuously arranged in a circumferential direction of the combustor, and
the auxiliary device member is attached to one of the outer peripheral concave portions.

2. The gas turbine according to claim 1, wherein the auxiliary device member includes an ignition device extending in one direction and configured to cause ignition in a combustion chamber of one of the combustion cylinders, and
an extending direction of the ignition device is inclined relative to a radial direction of the combustor.

3. The gas turbine according to claim 2, wherein the combustor includes a plurality of communication pipes configured to allow the combustion chambers of the combustion cylinders adjacent to each other to communicate with each other, and
the ignition device and the plurality of communication pipes are disposed in a manner so that a position of the ignition device corresponds to a position of one of the plurality of communication pipes in the axial direction of the combustor.

4. The gas turbine according to claim 1, wherein the auxiliary device member includes a sensor configured to detect a physical quantity of the air flowing through the air flow path.
